(19) United States
(12) Patent Application Publication
(10) Pub. No.: US 2012/0032880 A1
(43) Pub. Date: Feb. 9, 2012

(54) POINTING DEVICE AND DISPLAY APPARATUS HAVING THE SAME

(75) Inventors: Seung-min KIM, Seoul (KR); Myung-jae KIM, Suwon-si (KR); Ki-hong PARK, Suwon-si (KR)

(73) Assignee: SAMSUNG ELECTRONICS CO., LTD., Suwon-si (KR)

(21) Appl. No.: 13/010,833

(22) Filed: Jan. 21, 2011

(30) Foreign Application Priority Data
Aug. 3, 2010 (KR) 10-2010-0074964

(51) Int. Cl. G09G 5/08

(52) U.S. Cl. 345/157

(57) ABSTRACT

A display apparatus including a pointing device which generates a light beam and projects the light beam on a screen; a camera which detects a trace of the light beam imaged on the screen; and an image processing unit which processes an image corresponding to the trace of the light beam detected by the camera to display the image on the screen. The pointing device includes: a first light source unit which generates and emits a first light beam having a first wavelength range, a second light source unit which generates and emits a second light beam having a second wavelength range different from the first wavelength range, and a switching circuit which selectively applies power to one of the first light source unit and the second light source unit depending on a distance between the screen and the pointing device, so that one of the first light beam of the first wavelength range and the second light beam of the second wavelength range is selectively projected to form the light beam on the screen.

### CROSS-REFERENCE TO RELATED APPLICATION

This application claims priority from Korean Patent Application No. 10-2010-0074964, filed on Aug. 3, 2010 in the Korean Intellectual Property Office, the disclosure of which is incorporated herein by reference in its entirety.

### BACKGROUND

1. Field

Apparatuses and devices consistent with the exemplary embodiments relate to a pointing device which projects light beams on a screen and a display apparatus having the same, and more particularly, to a pointing device with a light emission structure to allow an image to be effectively displayed on a screen based on a trace of light beams projected on the screen, and a display apparatus having the same.

2. Description of the Related Art

A display apparatus for processing an image signal or image data which is input externally or stored therein through various processes and displaying an image on a panel or a screen based on the processed image signal or image data, may be implemented in various ways including a television (TV), a monitor, a portable media player or the like depending on its usage. Such a display apparatus may be implemented as an electronic board (“E-board”) which detects a trace formed on a screen and displays an image on the screen based on the detected trace.

An E-board type display apparatus may be a resistive type which detects a pressure on a resistive touch screen, an infrared type which detects imaging of an infrared beam projected on a screen, and so on.

However, the resistive type display apparatus detecting a trace by a touch on the screen has to employ the entire screen as a touch-enabled screen, which may result in an increase in production costs and difficulty in a user writing on a portion of the screen which is hard to be accessed by the user. Accordingly, such a resistive type display apparatus is not easy to implement in a large-sized screen. In addition, the infrared type display apparatus having the diffusion property of the infrared beam may provide an unclear trace of the infrared beam imaged on the screen when it is projected over a long distance depending on scattering of the infrared beam and the amount of infrared beam used in certain environments.

### SUMMARY

One or more exemplary embodiments provide a pointing device with an improved light emission structure to allow an image to be effectively displayed on a screen based on a trace of light beams projected on the screen, and a display apparatus having the same.

According to an exemplary embodiment, there is provided a display apparatus including: a pointing device which generates a light beam and projects the light beam on a screen; a camera which detects a trace of the light beam imaged on the screen; and an image processing unit which processes an image corresponding to the trace of the light beam detected by the camera to display the image on the screen, the pointing device including: a first light source unit which generates and emits the light beam having a first wavelength range, a second light source unit which generates and emits the light beam having a second wavelength range different from the first wavelength range, and a switching circuit which selectively applies power to one of the first light source unit and the second light source unit depending on a distance between the screen and the pointing device, so that the light beam of one of the first wavelength range and the second wavelength range is selectively projected.

The first wavelength range may be a range of infrared wavelength, and the second wavelength range may be a range of visible wavelength.

The display apparatus may further include a filter which is placed on a path of light input to and detected by the camera and passes an amount of the light beam of the range of visible wavelength reduced by a predetermined rate.

The switching circuit may apply the power to the first light source unit if the distance between the screen and the pointing device is smaller than a predetermined reference distance and apply the power to the second light source unit if the distance between the screen and the pointing device is larger than the predetermined reference distance.

The pointing device may further include a detecting unit which detects the distance between the screen and the pointing device and transfers a result of the detection to the switching circuit.

The pointing device may further include a user input unit which is configured to designate selective power application by the switching circuit.

The pointing device may further include a housing which has a user holdable rod-like shape and includes a first end portion in which the first and second light source units are placed.

The first light source unit may further include: a first light source which generates the light beam having the first wavelength range; and a hemispherical diffusing lens which diffuses the light beam input from the first light source.

The diffusing lens may be supported to the housing to move between a first position closer to the housing and a second position farther from the housing, and the pointing device may further include: an elastic member which elastically biases the diffusing lens toward the second position; and an electrode unit which makes electrical conduction to allow the switching circuit to apply power to the first light source unit when the diffusing lens is located in the first position due to an external pressure.

The second light source unit may include: a second light source which generates the light beam having the second wavelength range; and an optical duct member which guides the light beam input from the second light source to go straight in parallel.

The second light source may be located in the central region within the diffusing lens at the first end portion of the housing, and the optical duct member may extend to the outer side of the diffusing lens through a hole formed in the diffusing lens.

The image processing unit may be implemented as a projection type unit.

According to another aspect of an exemplary embodiment, there is provided a pointing device of a display apparatus, which generates a light beam and projects the light beam on a screen, including: a first light source unit which generates and emits the light beam having a first wavelength range; a second light source unit which generates and emits the light beam having a second wavelength range different from the first wavelength range; and a switching circuit which selectively applies power to one of the first light source unit and the second light source unit depending on a distance between the screen and the pointing device, so that the light beam of one of the first wavelength range and the second wavelength range is selectively projected.

The first wavelength range may be a range of infrared wavelength, and the second wavelength range may be a range of visible wavelength.

The switching circuit may apply the power to the first light source unit if the distance between the screen and the pointing device is smaller than a predetermined reference distance and apply the power to the second light source unit if the distance between the screen and the pointing device is larger than the predetermined reference distance.

The pointing device may further include a detecting unit which detects the distance between the screen and the pointing device and transfers a result of the detection to the switching circuit.

The pointing device may further include a user input unit which is configured to designate selective power application by the switching circuit.

The pointing device may further include a housing which has a user holdable rod-like shape and includes a first end portion in which the first and second light source units are placed.

The first light source unit may include: a first light source which generates the light beam having the first wavelength range; and a hemispherical diffusing lens which diffuses the light beam input from the first light source.

The diffusing lens may be supported to the housing to move between a first position closer to the housing and a second position farther from the housing, and the pointing device may further include: an elastic member which elastically biases the diffusing lens toward the second position; and an electrode unit which makes electrical conduction to allow the switching circuit to apply power to the first light source unit when the diffusing lens is located in the first position due to an external pressure.

The second light source unit may include: a second light source which generates the light beam having the second wavelength range; and an optical duct member which guides the light beam input from the second light source to go straight in parallel.

The second light source may be located in the central region within the diffusing lens at the first end portion of the housing, and the optical duct member may extend to the outer side of the diffusing lens through a hole formed in the diffusing lens.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a view showing an exemplary display apparatus according to a first exemplary embodiment;

FIG. 2 is a view showing a configuration of an image processing unit in the display apparatus shown in FIG. 1;

FIG. 3 is a graph showing a relative comparison of an amount of a visible light beam detectable by a camera depending on whether or not a filter is used in the display apparatus shown in FIG. 1;

FIG. 4 is a sectional side view showing a general structure of a pointing device in the display apparatus shown in FIG. 1;

FIG. 5 is a sectional side view showing a general structure of a pointing device according to a second exemplary embodiment; and

FIG. 6 is a view showing a configuration of a pointing device according to a third exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout. However, it is appreciated that it is not meant to exclude such omitted components from a display apparatus 1 of the exemplary embodiments.

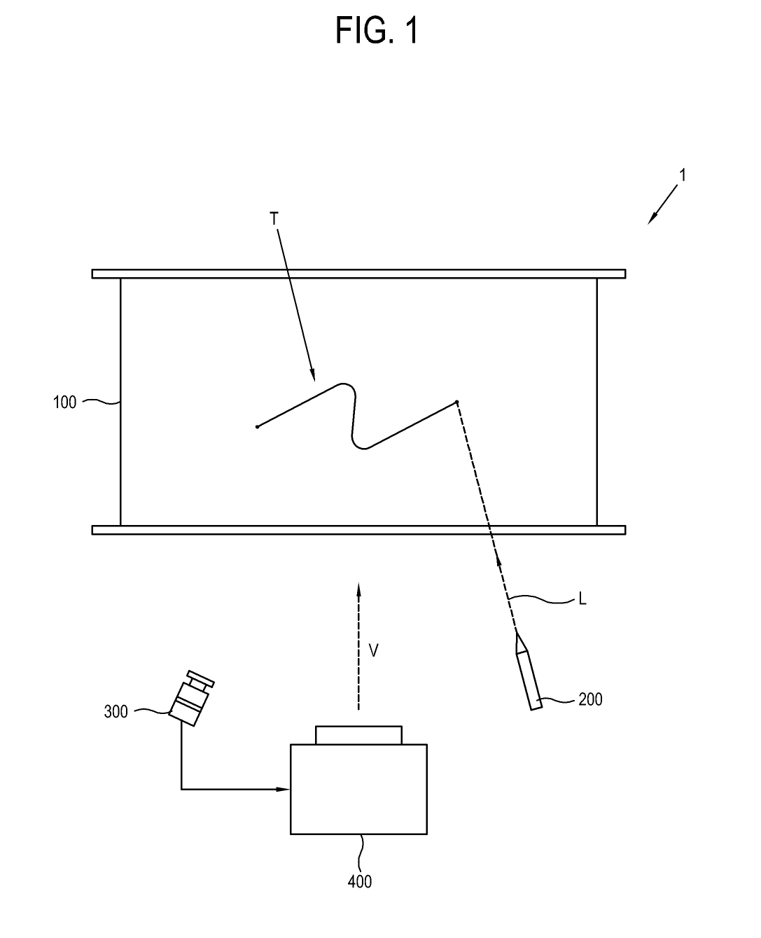

FIG. 1 is a view showing an exemplary display apparatus 1 according to a first exemplary embodiment.

Referring to FIG. 1, a display apparatus 1 according to the first exemplary embodiment includes a screen 100, a pointing device 200 which generates and projects a light beam L on the screen 100, a camera 300 which detects a trace T of the light beam imaged on the screen 100 by the pointing device 200, and an image processing unit 400 which processes an image corresponding to the trace T of the light beam L detected by the camera 300 so that the image can be displayed on the screen 100.

In the display apparatus 1, one of a light beam L having a first range of wavelength and a light beam L having a second range of wavelength different from the first range of wavelength is selectively projected on the screen 100 from the pointing device 200 in correspondence to a distance between the screen 100 and the pointing device 200. In this exemplary embodiment, the first range of wavelength corresponds to a range of infrared wavelength and the second range of wavelength corresponds to a range of visible wavelength.

Since the light beams L having the different ranges of wavelength have different optical properties, the image processing unit 400 may normally display an image corresponding to the trace T of the light beam L in correspondence to variation of the distance between the screen 100 and the pointing device 200 as the pointing device 200 projects a light beam L having an appropriate range of wavelength on the screen depending on the distance between the screen 100 and the pointing device 200.

The screen 100 is installed on an installation plane such as a wall for image display. The screen 100 may be implemented with various different sizes, colors and so on within a range in which an image V projected from the image processing unit 400 can be displayed. For example, the screen may have a white color which allows the image V to be more clearly displayed and the trace T of the light beam L to be easily detected by the camera 300.

The screen 100 may include, but is not limited to, flexible material for facilitation of attachment/detachment to/from the installation plane, solid material fixedly attached to the installation plane, or the like.

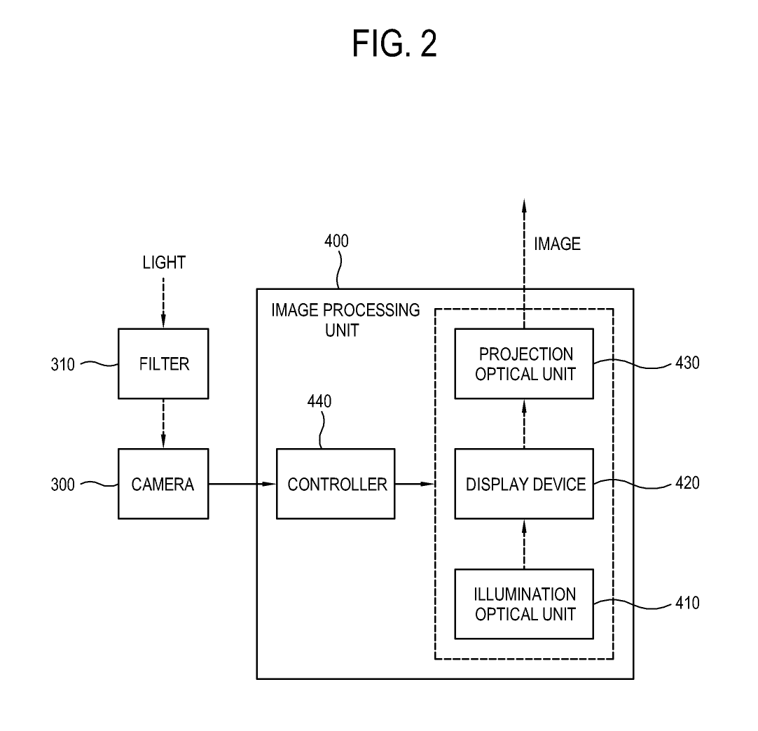

A configuration of the camera 300 and the image processing unit 400 will be now described with reference to FIG. 2. FIG. 2 is a view showing a configuration of the camera 300 and the image processing unit 400 in the display apparatus 1.

Referring to FIG. 2, the camera 300 detects the trace T of the light beam L imaged on the screen 100 and transfers the detected trace T to the image processing unit 400. The camera 300 may be separated communicatively from or incorporated into the image processing unit 400.

When the light beam L is imaged on the screen 100, the camera 300 receives light reflected from the screen and calculates a relative coordinate of the trace T of the light beam L on the screen 100. For this purpose, the camera 300 includes a lens system (not shown) for light receipt and a complementary metal oxide semiconductor (CMOS) or charge-coupled device (CCD) image sensor (not shown) for detection of light input through the lens system.

A filter 310 is disposed on a path of the light received in the camera 300. The filter 310 may be disposed with no restriction on its position as long as it can filter the light received in the camera 300. For example, the filter 310 may be combined with the lens system (not shown) for light receipt in the camera 300.

The filter 310 passes an amount of visible light reduced by a preset rate. In contrast, the filter 310 passes infrared light substantially without any reduction.

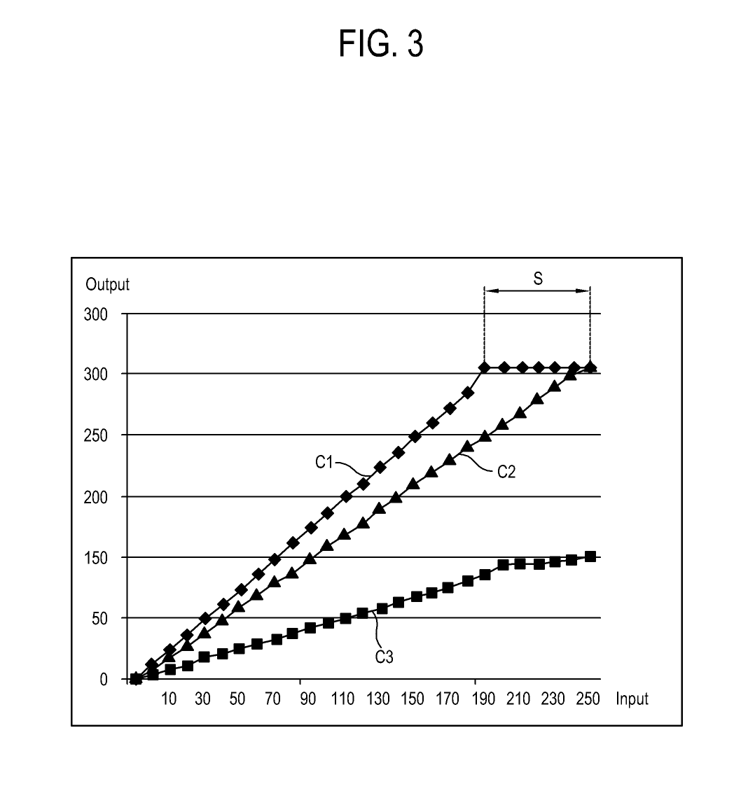

Hereinafter, the reason for application of the filter 310 to the camera 300 will be described with reference to FIG. 3. FIG. 3 is a graph showing a relative comparison of an amount of a visible light beam detectable by the camera 300 depending on whether or not a filter is used.

In the graph of FIG. 3, a horizontal axis represents relative numerical values of luminance of light input to the camera 300 and a vertical axis represents relative numerical values of luminance of light output from the camera 300. The relative numerical values on the horizontal and vertical axes are dimensionless, and a lower value indicates a lower luminance, whereas a higher value indicates a higher luminance.

A curve C1 involves non-application of the filter 310, i.e., the light received in the camera 300 does not pass through the filter 310. A curve C2 involves application of the filter 310, i.e., the light received in the camera 300 passes through the filter 310. A curve C3 involves recognition by a human's field of view.

As can be seen from the curve C1, the luminance of the light output from the camera 300 is in direct proportion to the luminance of the light input to the camera 300, which increases from 0 to about 190. However, if the luminance of the light input to the camera 300 exceeds 190, a section S occurs in which the luminance of the light output from the camera 300 does not increase but remains unchanged even with increase in the luminance of the light input to the camera.

This section S occurs when the light received in the camera 300 is out of a dynamic range which is a range of luminance of light recognizable by the camera 300. Specifically, an image sensor (not shown) in the camera 300 is saturated if it detects light having high luminance which exceeds the upper limit of the dynamic range. For example, when an image and the trace T of the light beam L are together displayed, the camera 300 may not recognize the trace T of the light beam L due to such a saturation effect although the trace T of the light beam L has a luminance higher than that of the image.

To avoid this problem, the filter 310 passes an amount of the light received in the camera 300 by a preset rate, for example, 15% to 20%, and transfers the resultant amount of the light to the camera 300. Accordingly, the dynamic range of the camera 300 is adjusted as shown in curve C2.

As shown in the curve C2, the luminance of the light output from the camera 300 is in direct proportion to the luminance of the light input to the camera 300 over the entire section without a section such as the section S in the curve C1. Namely, the application of the filter 310 to the camera 300 allows the camera 300 to clearly recognize the trace T of the light beam L even under light-intensive use environments.

Referring again to FIG. 2, the image processing unit 400 subjects the externally input image signal or image data to various processes and displays an image on the screen 100 based on the processed image signal or image data. In this exemplary embodiment, the image processing unit 400 may be implemented as a projection type unit although it may be implemented by any other type.

The image processing unit 400 includes an illumination optical unit 410 which generates and emits light, a display device 420 which displays an image on a plate based on the light emitted from the illumination optical unit 410, and a projection optical unit 430 which enlarges and projects the image displayed on the plate of the display device 420 on the screen 100. The image processing unit 400 further includes a controller 440 which controls operation of other elements 410, 420 and 430 of the image processing unit 400 so that the image based on information regarding coordinates of the trace T of the light beam L transferred from the camera 300 can be displayed on the screen 100.

The illumination optical unit 410 includes a light source (not shown) which generates light, and at least one optical lens (not shown) which adjusts various optical properties, such as collimation, equalization, polarization, condensation and so on, of the light from the light source (not shown). A plurality of optical lens (not shown) may be placed along an optical path for aberration correction.

The display device 420 forms an image by selectively transmitting or reflecting the light emitted from the illumination optical unit 410. The display device 420 may be implemented as a reflective display device which forms an image by selectively reflecting incident light in the unit of a pixel, or a transmissive liquid crystal display which selectively transmits incident light in the unit of a pixel. Examples of the reflective display device may include a digital micro-mirror device (DMD), a reflective liquid crystal on silicon (LOCOS) device, and other devices known in the art.

The projection optical unit 430 enlarges and displays the image formed on the display device 420 by enlarging and projecting the image formed on the display device 420 on the screen 100 using various lens configurations placed along the optical path.

Upon receiving the coordinate information of the trace T of the light beam L from the camera 300, the controller 440 controls the illumination optical unit 410 and the display device 420 such that an image corresponding to the received coordinate information can be displayed on the display device 420. That is, when the trace T of the light beam L projected from the pointing device 200 appears on the screen 100, the camera 300 detects the trace T and its coordinate information and transfers the detected coordinate information to the controller 440. Then, the controller 440 displays the image on the display device 420 based on the transferred coordinate information and the displayed image is projected onto the projection optical unit 430 and then is displayed on the screen 100.

Accordingly, when the trace T of the light beam L is formed on the screen 100 by the pointing device 200, the image corresponding to the trace T is displayed on the screen 100.

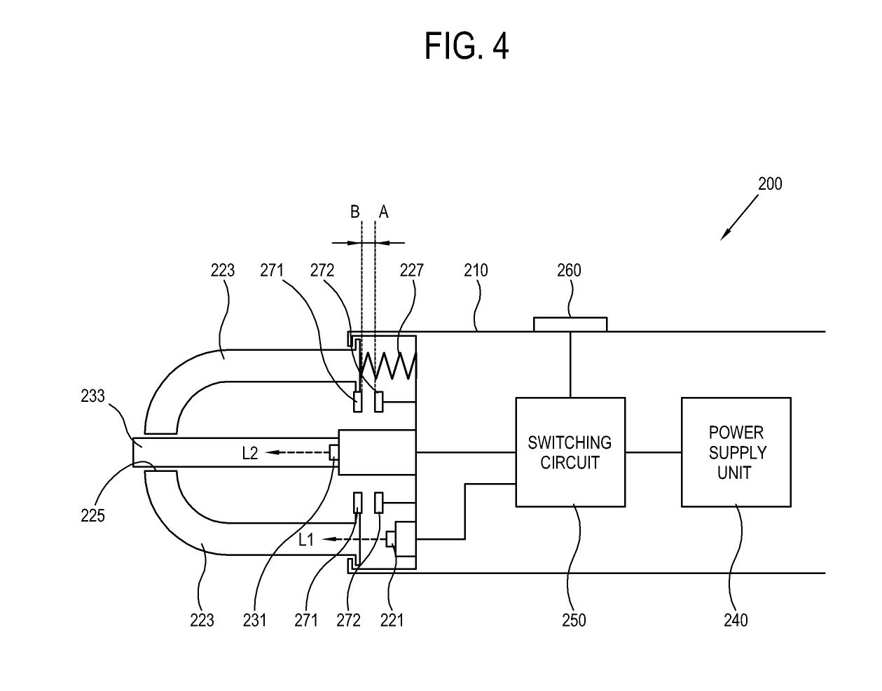

Hereinafter, the pointing device 200 will be described with reference to FIG. 4. FIG. 4 is a sectional side view showing a general structure of the pointing device 200 according to this exemplary embodiment.

Referring to FIG. 4, the pointing device 200 may selectively project one of a light beam L1 having a range of infrared wavelength and a light beam L2 having a range of visible wavelength, depending on a distance between the screen 100 and the pointing device 200.

Such selective projection is attributed to a difference in optical characteristics between diffusive infrared light and paralleling visible light. Thus, if the distance between the screen 100 and the pointing device 200 is smaller than a predetermined reference distance, the camera 300 can easily detect the trace T on the screen for the diffusive infrared light rather than for the paralleling visible light. In contrast, if the distance between the screen 100 and the pointing device 200 is larger than the reference distance, the camera 300 can easily detect the trace T on the screen for the paralleling visible light rather than for the diffusive infrared light since the infrared light is diffusive to make it difficult to form an image on the screen 100.

Accordingly, in this exemplary embodiment, depending on the distance between the screen 100 and the pointing device 200, the pointing device 200 is configured to project the light beam L1 having the range of infrared wavelength if the distance is relatively small and project the light beam L2 having the range of visible wavelength if the distance is relatively large. This allows the camera 300 to easily detect the trace T of one of the light beams L1 and L2 on the screen 100 even when the distance between the screen 100 and the pointing device 200 varies.

Here, the reference distance is a reference for distinguishing between a short distance where the light beam L1 having the infrared wavelength range is used and a long distance where the light beam L2 having the visible wavelength range is used. The reference distance may be variously determined depending on a use environment of the pointing device 200 such as light intensity of a surrounding environment, reflectivity of a screen, etc. Thus, the reference distance is not limited to a specific value or range.

As shown in FIG. 4, the pointing device 200 includes a housing 210, a first light source unit 221 and 223 which is placed at one end portion of the housing 210 and generates and emits the light beam L1 having a range of infrared wavelength, a second light source unit 231 and 233 which is placed at the one end portion of the housing 210 in a manner to be separated from the first light source unit 221 and 223 and generates and emits the light beam L2 having a range of visible wavelength, a power supply unit 240 which supplies power, a switching circuit 250 which switches to selectively provide power from the power supply unit 240 to one of the first light source unit 221 and 223 and the second light source 231 and 233, and a user input unit 260 which is provided to designate a switching operation of the switching circuit 250 with a user's manipulation.

The housing 210 is not limited in its shape, size and material but is preferably of a bar shape, which facilitates a user's holding of the pointing device 200 to project the light beams L1 and L2 on a desired site of the screen 100. In this exemplary embodiment, the housing 210 has a cylindrical rod-like shape and contains the power supply unit 240 and the switching circuit 250. In addition, the first light source unit 221 and 223 and the second light source unit 231 and 233 are disposed at the first end portion of the housing 210 and the user input portion 260 is disposed at an outer side to be held by the user.

The first light source unit 221 and 223 includes a first light source 221 which is electrically connected to the switching circuit 250 and generates and emits the light beam L1 having the range of infrared wavelength, and a diffusing lens 223 which diffuses the light beam L1 emitted from the first light source 221.

In response to application of power by the power supply unit 240 through the switching circuit 250, the first light source 221 generates the light beam L1 having the range of infrared wavelength, i.e., 780 nm to 1200 nm, and emits the generated light beam L1 to the diffusing lens 223. In this exemplary embodiment, the first light source 221 is disposed in an edge region at the first end portion of the housing 210.

The diffusing lens 223 has a circular or elliptical hemispherical shape and is configured to cover the first end portion of the housing 210. The diffusing lens 223 is disposed to project externally and convexedly from the first end portion of the housing 210, with an end portion of the diffusing lens 223 being supported on the edge region of the first end portion of the housing 210.

In this case, since the first light source 221 is disposed in the edge region at the first end portion of the housing 210, the light beam L1 emitted from the first light source 221 is incident into the end portion of the diffusing lens 223. The incident light beam L1 is externally output after being diffused over the entire diffusing lens 223 of the hemispherical shape, thereby increasing a size of optical spot imaged by the light beam L1.

In addition, the diffusing lens 223 is supported on the first end portion of the housing 210 in such a manner that the diffusing lens 223 can move between a first position A closer to the housing 210 and a second position B farther from the housing 210. In this case, an elastic member 227 to elastically bias the diffusing lens 223 toward the second position B is interposed between the diffusing lens 223 and the housing 210.

In addition, a first electrode 271 is coupled to the diffusing lens 223 and a second electrode 272 is coupled to the first end portion of the housing 210. The first and second electrodes 271 and 272 are electrically connected to the switching circuit 250. When the diffusing lens 223 is in the first position A, the first and second electrodes 271 and 272 make electrical conduction by mutual contact, thereby applying power to the first light source 221. A wiring structure of applying power to the first light source 221 by means of the switching circuit 250 upon making electrical conduction between the first and second electrodes 271 and 272 may be changed in its design by those skilled in the art without departing from the spirit and scope of the exemplary embodiment.

On the other hand, when the diffusing lens 223 is in the second position, the first and second electrodes 271 and 272 are separated and electrically isolated from each other. Even under this condition, it is to be understood that the switching circuit 250 may cause power to be applied to the first light source 221 by means of the user input unit 260.

In addition, since the second light source unit 231 and 233 is placed in the central area of the first end portion of the housing 210, the first and second electrodes 271 and 272 may be configured to have a ring-like shape surrounding the second light source unit 231 and 233 for the purpose of avoiding mutual interference.

For example, if a user is handwriting by pressing the tip of the pointing device 200 against the screen 100 formed of rigid material, the diffusing lens 223 is pressed in contact with the screen 100 and moves to the first position A against an elastic force of the elastic member 227. Accordingly, the first and second electrodes 271 and 272 make electrical conduction therebetween, thereby generating the light beam L1 from the first light source 221 and projecting it on the screen 100 through the diffusing lens 223.

If the user stops the handwriting with the pointing device 200 on the screen 100 and separates the pointing device 200 from the screen 100, the first and second electrodes 271 and 272 are separated from each other to stop the generation of the light beam L1 from the first light source 221. In this manner, when the user presses the pointing device 200 against the screen 100 for handwriting, the light beam L1 can be projected on the screen 100 without any user's manipulation through the user input unit 260.

The second light source unit 231 and 233 includes a second light source 231 which is electrically connected to the switching circuit 250 and generates and emits the laser light beam L2 having the range of visible wavelength, and an optical duct member 233 which guides the light beam L2 from the second light source 231 such that the light beam L2 goes straight in parallel.

The second light source 231 generates the light beam L2 having the range of visible wavelength, i.e., 400 nm to 780 nm. The second light source 231 is disposed in the central region of the first end portion of the housing 210 in an inner side of the diffusing lens 223.

The optical duct member 233 has a rod-like shape having one end portion coupled to or disposed adjacent to the second light source 231 and the other end portion extending to the outer side of the diffusing lens 223 through a hole 225 formed in the diffusing lens 223. When the light beam L2 from the second light source 231 is incident into the one end portion, the optical duct member 233 guides the light beam L2 to go straight without being diffused toward the diffusing lens 223 such that the light beam L2 exits through the other end portion in the outer side of the diffusing lens 223.

If the optical duct member 233 is not present, the light beam L2 is diffused by the diffusing lens 223 since the second light source 231 is inside the diffusing lens 223, which may make it difficult to form a trace T by the light beam L2 on the screen 100 at a long distance. Thus, by employing the optical duct member 233 which guides the light beam L2 from the second light source 231 to the outer side of the diffusing lens 223, it is possible to minimize the diffusion of the light beam L2 by the diffusing lens 223.

The power supply unit 240 may be implemented by a replaceable battery or rechargeable battery built in the housing 210 for supply of DC power.

The switching circuit 250 selectively provides power from the power supply unit 240 for one of the first light source 221 and the second light source 231. Such an operation of the switching circuit 250 may be controlled by the user input unit 260 or depending on whether or not electrical conduction is made between the first and second electrodes 271 and 272. The switching circuit 250 may be configured in different ways without departing from the spirit and scope of the exemplary embodiment.

The user input unit 260 is disposed at the outer side of the housing 210 such that a user can manipulate it to control the operation of the switching circuit 250. That is, the user may manipulate the user input unit 260 so that the light beam L1 having the range of infrared wavelength or the light beam L2 having the range of visible wavelength can be generated.

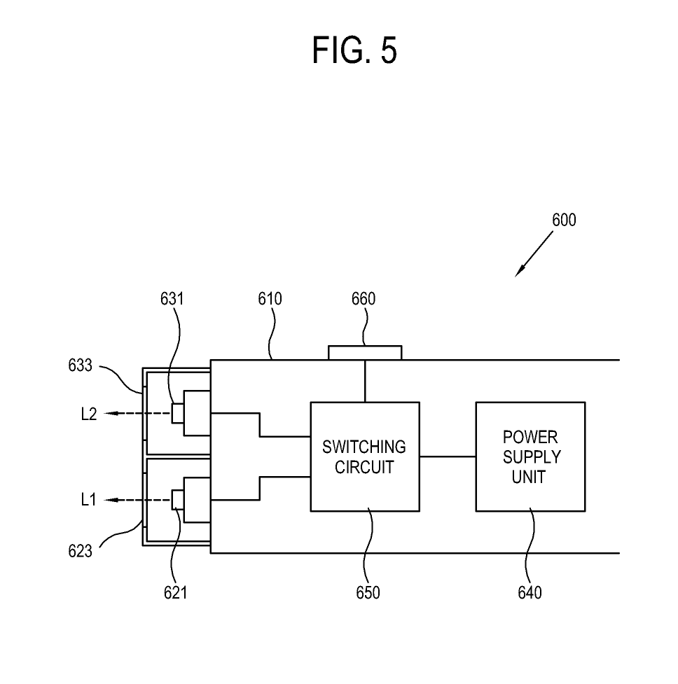

A pointing device 600 according to a second exemplary embodiment, having a structure different from that of the first exemplary embodiment, will be hereinafter described with reference to FIG. 5.

FIG. 5 is a sectional side view showing a general structure of a pointing device 600 according to the second exemplary embodiment.

Referring to FIG. 5, the pointing device 600 according to the second exemplary embodiment includes a housing 610, a first light source unit 621 and 623 which is placed at a first end portion of the housing 610 and generates and emits a light beam L1 having a range of infrared wavelength, a second light source unit 631 and 633 which is placed at the first end portion of the housing 610 in a manner to be separated from the first light source unit 621 and 623 and generates and emits a light beam L2 having a range of visible wavelength, a power supply unit 640, a switching circuit 650, and a user input unit 660.

The first light source unit 621 and 623 includes a first light source 621 which generates the light beam L1, and a first light source lens 623 which adjusts the light beam L1 to have predetermined optical properties. The second light source unit 631 and 633 includes a second light source 631 which generates the light beam L2, and a second light source lens 633 which adjusts the light beam L2 to have predetermined optical properties. The first light source lens 623 and the second light source lens 633 may be implemented in various ways including diffusion, collimation, condensation and so on depending on optical properties to be adjusted.

Unlike the first exemplary embodiment, the second exemplary embodiment does not require the optical duct member 233 and the hole 225 of the first exemplary embodiment since the present exemplary embodiment has no structure to interfere with the light beam L2.

Various elements of the second exemplary embodiment are analogous to elements of the first exemplary embodiment, and therefore, an explanation of such elements will not be repeated for the purpose of brevity of the description.

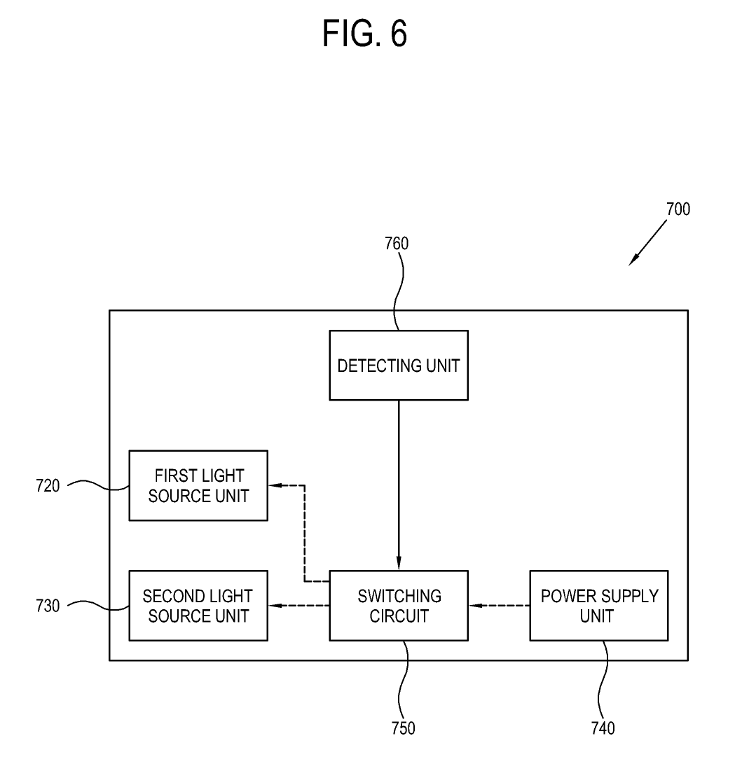

Although it is illustrated in the first and second exemplary embodiments that the switching operation of the switching circuits 250 and 650 is controlled by a user's manipulation through the user input units 260 and 660, the exemplary embodiments are not limited thereto. For example, a switching operation of a switching circuit 750 may be automatically performed without requiring a user's separate manipulation, as will be described below with reference to FIG. 6.

FIG. 6 is a view showing a configuration of a pointing device 700 according to a third exemplary embodiment.

Referring to FIG. 6, the pointing device 700 according to the third exemplary embodiment includes a first light source unit 720 which generates and emits a light beam L1 having a range of infrared wavelength, a second light source unit 730 which generates and emits a light beam L2 having a range of visible wavelength, a power supply unit 740 which supplies power, a switching circuit 750 which selectively applies the power from the power supply unit 740 for one of the first light source unit 720 and the second light source unit 730, and a detecting unit 760 which detects a distance between the screen 100 and the pointing device 700 and transfers a result of the detection to the switching circuit 750.

Configuration of the first light source 720, the second light source 730 and the power supply unit 740 may be analogous to corresponding elements of the first and second exemplary embodiments, and therefore, explanation of such configuration will not be repeated for the purpose of brevity of the description.

The detecting unit 760 which detects the distance between the screen 100 and the pointing device 700, may be implemented in various ways including, but is not limited to, ultrasonography. In addition, the detecting unit 760 may be configured in various ways, such as by installing in the pointing device 700 as in this exemplary embodiment, installing in the screen 100, installing in both in a corresponding manner, or installing in a separate third position such that a result of detection by the detecting unit 760 can be wirelessly transferred to the switching circuit 750.

Based on the result of detection transferred from the detecting unit 760, the switching circuit 750 applies power from the power supply unit 740 to one of the first and second light sources 720 and 730. For this purpose, the switching circuit 750 may further include a separate microcontroller.

For example, the detecting unit 760 may transfer a low signal to the switching circuit 750 if a detected distance is smaller than a predetermined reference distance and transfer a high signal to the switching circuit 750 if the detected distance is larger than the predetermined reference distance. The switching circuit 750 applies power from the power supply unit 740 to the first light source 720 upon receiving the low signal from the detecting unit 760 and applies power from the power supply unit 740 to the second light source 730 upon receiving the high signal from the detecting unit 760.

Accordingly, the light beam L1 having the range of infrared wavelength and the light beam L2 having the range of visible wavelength may be automatically and selectively projected on the screen 100 depending on the distance between the screen 100 and the pointing device 700 without requiring a user's separate manipulation.

Further, this exemplary embodiment may additionally include a separate user input unit (not shown) for turning the power supply unit 740 on/off.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. A display apparatus comprising:
a pointing device which generates a light beam and projects the light beam on a screen;
a camera which detects a trace of the light beam imaged on the screen; and
an image processing unit which processes an image corresponding to the trace of the light beam detected by the camera to display the image on the screen,
the pointing device comprising:
a first light source unit which generates and emits a first light beam having a first wavelength range,
a second light source unit which generates and emits a second light beam having a second wavelength range different from the first wavelength range, and
a switching circuit which selectively applies power to one of the first light source unit and the second light source unit depending on a distance between the screen and the pointing device, so that one of the first light beam of the first wavelength range and the second light beam of the second wavelength range is selectively projected to form the light beam on the screen.

2. The display apparatus according to claim 1, wherein the first wavelength range is a range of infrared wavelength, and the second wavelength range is a range of visible wavelength.

3. The display apparatus according to claim 2, further comprising a filter which is placed on a path of light input to and detected by the camera, and passes an amount of the light beam of the range of visible wavelength reduced by a predetermined rate.

4. The display apparatus according to claim 2, wherein the switching circuit is configured to apply the power to the first light source unit if the distance between the screen and the pointing device is smaller than a predetermined reference distance and configured to apply the power to the second light source unit if the distance between the screen and the pointing device is larger than the predetermined reference distance.

5. The display apparatus according to claim 4, further comprising a detecting unit which detects the distance between the screen and the pointing device and transfers a result of the detection to the switching circuit.

6. The display apparatus according to claim 4, wherein the pointing device further comprises a user input unit which is configured to designate a selective power application by the switching circuit.

7. The display apparatus according to claim 2, wherein the pointing device further comprises a rod-shaped housing which comprises a first end portion in which the first and second light source units are placed.

8. The display apparatus according to claim 7, wherein the first light source unit comprises:
a first light source which generates the first light beam having the first wavelength range; and
a hemispherical diffusing lens which diffuses the first light beam input from the first light source.

9. The display apparatus according to claim 8, wherein the diffusing lens is connected to the housing so as to be movable between a first position closer to the housing and a second position farther from the housing, and
wherein the pointing device further comprises:
an elastic member which elastically biases the diffusing lens toward the second position; and
an electrode unit which makes electrical conduction to allow the switching circuit to apply power to the first light source unit when the diffusing lens is located in the first position due to an external pressure.

10. The display apparatus according to claim 9, wherein the second light source unit comprises:
a second light source which generates the second light beam having the second wavelength range; and
an optical duct member which guides the second light beam input from the second light source to go straight in parallel.

11. The display apparatus according to claim 10, wherein the second light source is located in a central region within the diffusing lens at the first end portion of the housing, and
wherein the optical duct member extends to the outer side of the diffusing lens through a hole formed in the diffusing lens.

12. The display apparatus according to claim 1, wherein the image processing unit is implemented as a projection type unit.

13. A pointing device of a display apparatus, the pointing device comprising:
a first light source unit which generates and emits a first light beam having a first wavelength range;
a second light source unit which generates and emits a second light beam having a second wavelength range different from the first wavelength range; and
a switching circuit which selectively applies power to one of the first light source unit and the second light source unit depending on a distance between a screen of the display apparatus and the pointing device, so that one of the first light beam of the first wavelength range and the second light beam of the second wavelength range is selectively projected on the screen of the display apparatus.

14. The pointing device according to claim 13, wherein the first wavelength range is a range of infrared wavelength, and the second wavelength range is a range of visible wavelength.

15. The pointing device according to claim 14, wherein the switching circuit applies the power to the first light source unit if the distance between the screen and the pointing device is smaller than a predetermined reference distance and applies the power to the second light source unit if the distance between the screen and the pointing device is larger than the predetermined reference distance.

16. The pointing device according to claim 15, further comprising a detecting unit which detects the distance between the screen and the pointing device and transfers a result of the detection to the switching circuit.

17. The pointing device according to claim 15, further comprising a user input unit which is configured to designate a selective power application by the switching circuit.

18. The pointing device according to claim 14, further comprising a rod-shaped housing which comprises a first end portion in which the first and second light source units are placed.

19. The pointing device according to claim 18, wherein the first light source unit comprises:
a first light source which generates the first light beam having the first wavelength range; and
a hemispherical diffusing lens which diffuses the first light beam input from the first light source.

20. The pointing device according to claim 19, wherein the diffusing lens is connected to the housing so as to be movable between a first position closer to the housing and a second position farther from the housing,
the pointing device further comprising:
an elastic member which elastically biases the diffusing lens toward the second position; and
an electrode unit which makes electrical conduction to allow the switching circuit to apply power to the first light source unit when the diffusing lens is located in the first position due to an external pressure.

21. The pointing device according to claim 20, wherein the second light source unit includes:
a second light source which generates the second light beam having the second wavelength range; and
an optical duct member which guides the second light beam input from the second light source to go straight in parallel.

22. The pointing device according to claim 21, wherein the second light source is located in a central region within the diffusing lens at the first end portion of the housing, and
wherein the optical duct member extends to the outer side of the diffusing lens through a hole formed in the diffusing lens.

23. A display system comprising:
a screen,
a pointing device which selectively generates and projects onto the screen one of a first light beam having a first wavelength range and a second light beam having a second wavelength range different from the first wavelength range;
a camera which detects a trace of the one of the first light beam and the second light beam projected on the screen; and
an image processing unit which processes an image corresponding to the trace of the one of the first light beam and the second light beam detected by the camera to display the image on the screen.

24. The display system according to claim 23, wherein the pointing device selectively generates and projects onto the screen the one of the first light beam and the second light beam projected on the screen depending on a distance between the screen and the pointing device.
